(19) United States
(12) Patent Application Publication
(10) Pub. No.: US 2004/0241537 A1
(43) Pub. Date: Dec. 2, 2004

(54) Air battery

(76) Inventors: Tetsuo Okuyama, Yokohama-shi (JP); Takashi Kuboki, Tokyo (JP); Takahisa Ohsaki, Yokohama-shi (JP); Norio Takami, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/807,333

(22) Filed: Mar. 24, 2004

(30) Foreign Application Priority Data
Mar. 28, 2003 (JP) 2003-089697

(51) Int. Cl. H01M 2/12; H01M 12/06; H01M 4/38; H01M 4/40

(52) U.S. Cl. 429/86; 429/176; 429/231.9; 429/231.6; 429/27

(57) ABSTRACT

The invention presents an air battery comprising a battery container having a surface in which air pores are formed, an electrode group provided in the battery container and including an air positive electrode, and a laminated sheet including a barrier film which is provided between the surface and the air positive electrode, and of which oxygen permeation coefficient is 1×10⁻¹⁴ mol·m/m²·sec·Pa or less, and a gap holding member which is laminated on the barrier film and is opposite to the air positive electrode, and the gap holding member comprising at least one selected from the group consisting of a porous film, a nonwoven fabric, and a woven fabric, wherein the air pores of the battery container are closed by the laminated sheet.

### CROSS-REFERENCE TO RELATED APPLICATIONS

This application is based upon and claims the benefit of priority from prior Japanese Patent Application No. 2003-089697, filed Mar. 28, 2003, the entire contents of which are incorporated herein by reference.

### BACKGROUND OF THE INVENTION

1. Field of the Invention

The present invention relates to an air battery using oxygen as a positive electrode active material, and more particularly to an air battery comprising a nonaqueous electrolyte.

2. Description of the Related Art

The market for personal digital equipment such as cellphones and electronic mail terminals has recently begun to expand rapidly, and as these appliances are more and more reduced in size and weight, the power supplies are also demanded to be smaller and lighter. For these portable appliances, at present, lithium ion secondary batteries having a high energy density are mainly used, but a higher capacity is demanded.

The air battery using the oxygen in air as a positive electrode active material does not require any space for incorporating the active material, and is hence expected to have a high capacity. As a lithium secondary battery using metal lithium as a negative electrode active material and oxygen as a positive electrode active material, an air-lithium secondary battery having the configuration as described below is disclosed in J. Electrochem. Soc., Vol. 143, No. 1, 1-5, January 1996.

This air-lithium secondary battery disclosed comprises a catalyst layer, an air positive electrode, a negative electrode, a polymer electrolyte film interposed between the air positive electrode and the negative electrode, and an oxygen permeation film laminated on the air positive electrode. The catalyst layer is formed of acetylene black containing cobalt. The air positive electrode is a polymer electrolyte film containing polyacrylonitrile, ethylene carbonate, propylene carbonate, and LiPF₆, which is press-bonded to nickel mesh or aluminum mesh. On the other hand, the negative electrode is formed of a lithium foil. This four-layer laminated body is sealed in a laminate bag.

In this air-lithium secondary battery, since the air positive electrode and negative electrode are adhered by way of a polymer electrolyte film of high viscosity, the capacity of the air positive electrode per gram of carbon is as high as 1600 mAh/g, and a considerably large capacity is obtained as compared with the capacity of 160 mAh/g of lithium cobalt oxide used as a positive electrode active material for a lithium ion secondary battery.

The positive electrode active material of the air-lithium battery is oxygen in air, and acetylene black containing cobalt is a catalyst for ionizing the oxygen. Therefore, theoretically, the discharge capacity of the air positive electrode per unit carbon weight is expected to be very large, but actually it is limited to about 10 times of lithium cobalt oxide. In an actual battery, the volume power density (W/L) is more important than the weight power density (W/Kg), the difference in volume power density is much smaller between the air lithium battery using carbon material of light specific weight as the positive electrode catalyst and the secondary battery using lithium cobalt oxide as the positive electrode.

In addition, the air-lithium battery, which uses a liquid organic electrolyte as the electrolyte, entails the drawback that the contact tightness becomes uneven between layers since the separator layer provided between the positive electrode and the negative electrode has a low contact tightness. As a solution to this drawback and secure the contact tightness between the positive electrode and negative electrode, J. Electrochem. Soc., Vol. 149, No. 9, A1190-A1195 (2002), published September 2002 has proposed a battery in which a three-layer laminated structure made of a positive electrode, a separator and a negative electrode formed on a polypropylene block substrate is tied with a nickel wire. It should be noted here that when the contact tightness is lowered, the output characteristic is significantly decreased and the battery cannot be used for a long period.

### BRIEF SUMMARY OF THE INVENTION

It is hence an object of the invention to provide an air battery which can be used for a long period in the atmosphere.

According to a first aspect of the present invention, there is provided an air battery comprising:

a battery container having a surface in which air pores are formed;

an electrode group provided in the battery container and including an air positive electrode, a negative electrode, and a separator provided between the air positive electrode and the negative electrode; and

a laminated sheet including a barrier film which is provided between the surface of the battery container and the air positive electrode of the electrode group, and of which oxygen permeation coefficient is 1×10⁻¹⁴ mol·m/m²·sec·Pa or less, and a gap holding member which is laminated on the barrier film and is opposite to the air positive electrode, and the gap holding member comprising at least one selected from the group consisting of a porous film, a nonwoven fabric, and a woven fabric, wherein the air pores of the battery container are closed by the laminated sheet.

According to a second aspect of the present invention, there is provided an air battery comprising:

a battery container having air pores;

an electrode group provided in the battery container and including an air positive electrode, a negative electrode, and a separator provided between the air positive electrode and the negative electrode; and

a laminated sheet provided between the battery container and the electrode group, and the laminated sheet comprising a barrier film of which the oxygen permeation coefficient is 1×10⁻¹⁴ mol·m/m²·sec·Pa or less, and a gap holding member which is laminated on the barrier film and comprises at least one selected from the group consisting of a porous film, a nonwoven fabric, and a woven fabric,

wherein the air positive electrode of the electrode group is opposite to the gap holding member of the laminated sheet.

### BRIEF DESCRIPTION OF THE SEVERAL VIEWS OF THE DRAWING

FIG. 1 is a perspective view showing a structure of one embodiment of an air battery according to the invention.

FIG. 2 is a sectional view of the air battery taken along the line II-II in FIG. 1.

FIG. 3 is a sectional view schematically showing a laminated sheet for use in the air battery in FIG. 1.

FIG. 4 is a schematic diagram showing a positional relation of an air pore, a barrier film and a gap holding member in the air battery in FIG. 1.

FIG. 5 is a perspective view showing a structure of another embodiment of the air battery according to the invention.

FIG. 6 is a sectional view of the air battery taken along the line VI-VI in FIG. 5.

FIG. 7 is a perspective view showing a structure of a different embodiment of the air battery according to the invention.

FIG. 8 is a sectional view of the air battery taken along the line VIII-VIII in FIG. 7.

FIG. 9 is a perspective view showing a structure of a further embodiment of the air battery according to the invention.

FIG. 10 is a sectional view of the air battery taken along the line X-X in FIG. 9.

FIG. 11 is a characteristic diagram showing time-course changes of voltage, current, and internal pressure during discharge of test cells in a thermostatic oven.

FIG. 12 is a characteristic diagram showing the internal pressure within the metal container along with time under atmosphere of laboratory air in the case where the opening section of the metal container filled with argon gas is sealed by the barrier film.

### DETAILED DESCRIPTION OF THE INVENTION

In a nonaqueous electrolytic air battery using an alkaline metal such as lithium, an alkaline earth metal, or alloy containing these metal elements as a negative electrode active material, the active material is consumed sequentially from the surface of the negative electrode by voltaic reaction. Therefore, it is hard to maintain a sufficient contact tightness between the air positive electrode and the negative electrode by way of a separator, and it is preferred to apply mechanical pressure from outside the electrode group comprising the air positive electrode, separator and negative electrode.

As disclosed in J. Electrochem. Soc., Vol. 143, No. 1, 1-5, January 1996, the air battery is generally low in current density per unit area of the air positive electrode. Hence, it is desired to increase the air positive electrode area for practical use of the air battery.

The present inventors attempted to laminate a gap holding member on an electrode group and arrange a non-porous and oxygen permeable polymer film to serve as a barrier film between the gap holding member and a battery container-surface having air pores. They have found that with the above-described structure, the internal pressure in the battery container becomes lower than the atmospheric pressure during continuous discharge, which is carried out by removing the seal tape that covers the air pores of the battery container for shutting down the air, thereby enhancing the contact tightness of the electrode group.

To maintain the contact tightness of the electrode group containing the air positive electrode and negative electrode, it is preferred to apply an external stress of 0.1 to 80 kPa. The reason is as explained below. If the external stress is less than 0.1 kPa, the contact tightness of the air positive electrode, separator and negative electrode may be insufficient. On the other hand, if a stress over 80 kPa is applied, the separator positioned between the air positive electrode and the negative electrode may become partly thin, and an internal short-circuit may occur.

By using a non-porous polymer film with an oxygen permeation coefficient of 1×10⁻¹⁴ mol·m/m²·sec·Pa or less as the barrier film, drop of the atmospheric pressure in the battery container can be gradually promoted along with start of discharge, and the atmospheric pressure in the battery container can be set lower than the atmospheric pressure by 0.1 to 80 kPa during continuous discharge, so that a sufficient contact tightness can be assured in the air positive electrode, separator and negative electrode. However, when the barrier film thickness is 1 to 100 μm, if the oxygen permeation coefficient is less than 5×10⁻¹⁷ mol·m/m²·sec·Pa, supply of oxygen to the air positive electrode may be insufficient, and hence when the thickness of the barrier film is 1 to 100 μm, the oxygen permeation coefficient of the barrier film is preferred to be 1×10⁻¹⁶ mol·m/m²·sec·Pa or more.

The ratio of the gap in the battery container except for the portion of the laminated sheet is preferred to be 5 to 40% in order to maintain the internal pressure in the battery container. The reason is explained below. If the ratio of the gap is less than 5%, the internal pressure in the battery container is likely to fluctuate. If the ratio of the gap is over 40%, it takes much time until the internal pressure in the battery container declines to a range lower than the atmospheric pressure by 0.1 to 80 kPa, and there is a possibility of a drop in battery performance.

By providing a gap holding member including at least one type selected from the group consisting of a porous film, a nonwoven fabric and a woven fabric at the barrier film, and the gap holding member being opposite to the electrode group, the gaps in the electrode group can be maintained so as not to be crushed by the atmospheric pressure. Instead of the gap holding member, a microgranular spacer may be used.

Further, by providing a second gap holding member containing at least one type selected from the group consisting of a porous film, a nonwoven fabric and a woven fabric between the air pores of the battery container and the barrier film, the entire surface of the barrier film can be effectively utilized as an oxygen diffusion film.

By forming the battery container of the air battery by using a packaging material such as laminate film containing aluminum, and adhering the barrier film end to the inside of the packaging material with adhesive, bonding or fusing, the air battery with the barrier film can be formed easily. Moreover, when Young's modulus and the thickness of the packaging material satisfy formula (1), the contact tightness of the electrode group including the air positive electrode and negative electrode can be maintained:

(Y×T)<10² (1)

where Y is Young's modulus (MPa) of the packaging material, and T is the thickness (m) of the packaging material.

When the product of (Y×T) is greater than 10², deformation of the packaging material is insufficient when the pressure becomes negative in the battery container, and hence the contact tightness of the electrode group may be lowered.

The nonaqueous electrolyte air battery of one embodiment of the present invention can be also used as a secondary battery including the negative electrode capable of intercalating and deintercalating metal ions.

One embodiment of the air battery of the invention is explained below while referring to the accompanying drawings.

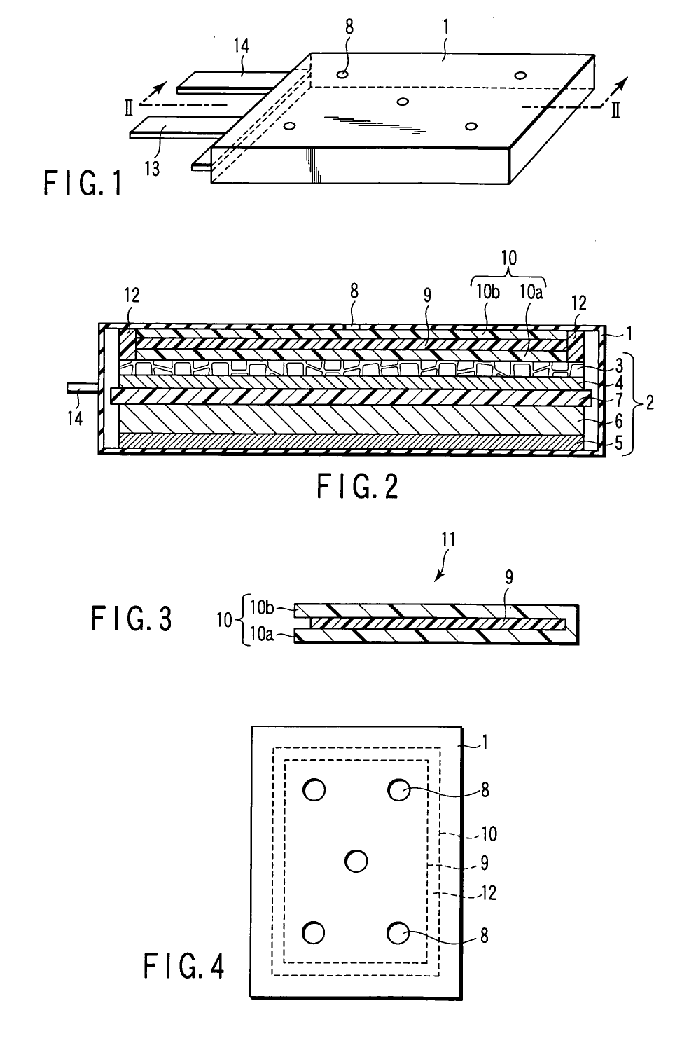

As shown in FIGS. 1 and 2, an electrode group 2 is contained in a battery container 1 made of a laminate film. The laminate film contains a thermoplastic resin layer, and is further preferred to contain an aluminum layer. The battery container 1 has a bag shape and is formed by laminating the laminate film with the thermoplastic resin layer by heat fusing. The electrode group 2 comprises a positive electrode having a gas diffusion positive electrode layer 4 carried on a positive electrode current collector 3 having, for example, a porous conductive substrate, a negative electrode having a negative electrode active material layer 6 carried on a negative electrode current collector 5 having, for example, a porous conductive substrate, and a separator 7 arranged between the air positive electrode and the negative electrode. An electrolyte is held in the air positive electrode, separator, and negative electrode.

The surface facing the air positive electrode of the battery container 1 has a plurality of air intake pores 8 (hereinafter called air pores). As shown in FIG. 3, a barrier film 9 with an oxygen permeation coefficient of 1×10⁻¹⁴ mol·m/m²·sec·Pa or less made of, for example, hydrophobic thermoplastic resin is held between two folds of a gap holding member 10 made of, for example, a microporous film of hydrophobic thermoplastic resin, thereby obtaining a barrier film group 11 as a laminated sheet. As shown in FIG. 4, when the end of the gap holding member 10 of the obtained barrier film group 11 is heat sealed to the thermoplastic resin layer inside of the battery container 1, the air pores 8 are covered with the barrier film group 11, while the gap holding member 10 and barrier film 9 are integrated with each other. The region enclosed by four surfaces of the barrier film 9 and four surfaces of the gap holding member 10 in FIG. 4 is a heat sealing area 12. In the case of heat sealing, the thermoplastic resin of the gap holding member 10 and the thermoplastic resin of the barrier film 9 are preferred to be of the same kind, or if the thermoplastic resins are different kinds, they are preferred to be compatible. If the thermoplastic resin of the gap holding member 10 and the thermoplastic resin of the barrier film 9 are not compatible, they may be adhered by using an arbitrary adhesive.

A gap holding member 10a between the positive electrode current collector 3 and the barrier film 9 is a first gap holding member, which can contribute to improvement of contact tightness of the electrode group. On the other hand, a gap holding member 10b between the battery container-surface having air pores and the barrier film 9 is a second gap holding member, which functions as a protective layer of the barrier film 9 and a gas diffusion layer.

The barrier film group 11 isolates the electrode group 2 from the atmosphere, and direct contact between the electrode group 2 and the atmosphere is avoided. One end of a positive electrode terminal 13 is electrically connected to the positive electrode current collector 3, and the other end projects outside of the battery container 1. One end of a negative electrode terminal 14 is electrically connected to the negative electrode current collector 5, and the other end projects outside of the battery container 1.

On the outer surface of the battery container 1, although not shown in the drawing, a seal tape for sealing the air pores 8 can be provided while the battery is not installed.

In the air battery having such a configuration, air is supplied into the battery container 1 from the air pores 8, and the supplied air diffuses the second gap holding member 10b and spreads above the surface. The barrier film 9 selectively passes oxygen, and the air passing through the second gap holding member 10b passes through the barrier film 9, so that unnecessary components such as moisture and nitrogen can be removed, and the oxygen-enriched gas is supplied into the gas diffusion positive electrode layer 4 through the first gap holding member 10a, thereby causing discharge reaction. Along with progress of discharge, the negative electrode active material layer 6 is consumed, while the pressure becomes negative in the battery container 1. The specific mechanism of pressure becoming negative is unknown, but it is estimated that the gas held in the gap holding member 10 when manufacturing the air battery in an inert gas atmosphere of argon gas or the like is released into the atmosphere by discharge, thereby causing the internal pressure in the battery container to be lower than the atmospheric pressure.

As the pressure becomes negative in the battery container 1, the barrier film group 11 can pressurize the surface of the electrode group 2 uniformly by the pressure difference from the atmospheric pressure. Therefore, the contact can be kept tight among the air positive electrode, separator and negative electrode, so that a high discharge capacity can be maintained during use for a long period. Besides, providing the first and second gap holding members makes it possible to uniformly diffuse oxygen gas in the air positive electrode, so that unreaction spots of the air positive electrode and negative electrode can be decreased.

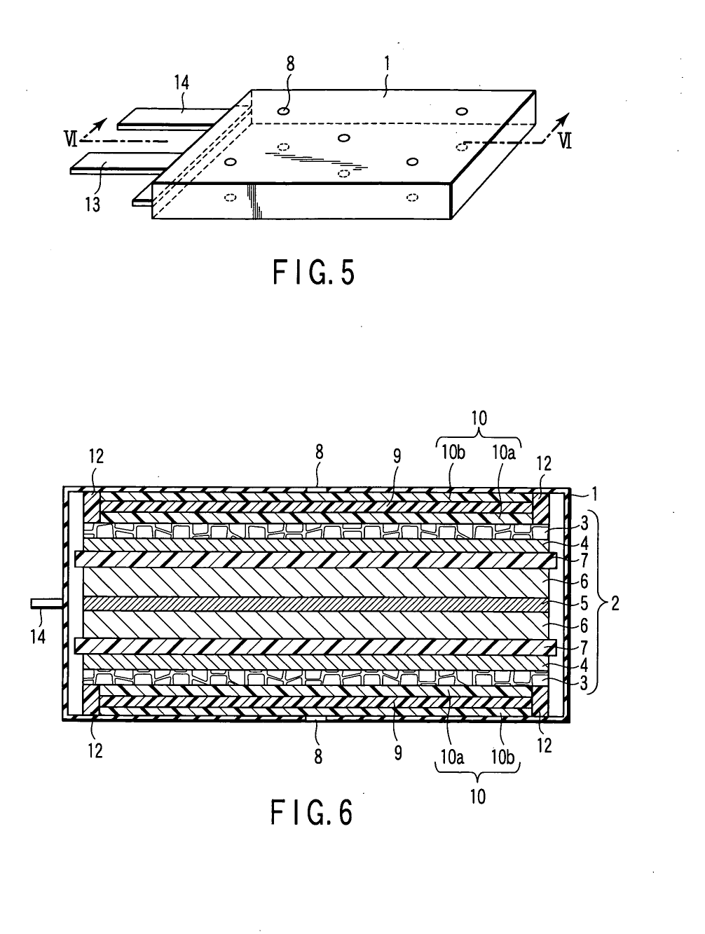

In FIGS. 1 to 4, only one surface of the electrode group 2 is the air positive electrode, but the both surfaces of the electrode group may be also formed as the air positive electrode. Such one embodiment is shown in FIGS. 5 and 6. In FIGS. 5 and 6, same parts as in FIGS. 1 to 4 are identified with same reference numerals, and duplicate explanation is omitted.

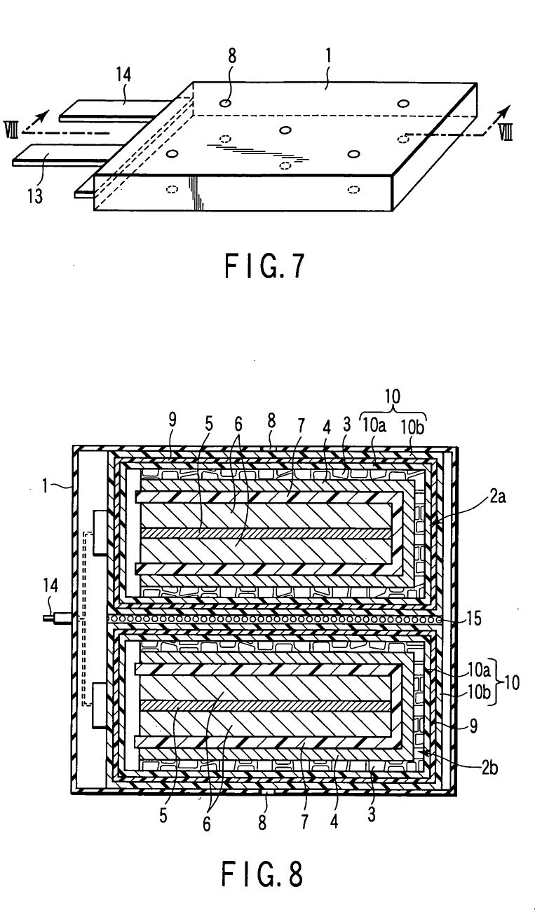

In FIGS. 1 to 6, the barrier film group 11 is fixed inside of the battery container 1 and the air poles 8 are closed by the barrier film group 11. However, when the electrode group 2 is contained in a bag of the barrier film group 11, it is not required to fix the barrier film group 11 in the inner surface of the battery container 1. Such one embodiment is shown in FIGS. 7 to 10. In FIGS. 7 to 10, same parts as in FIGS. 1 to 4 are identified with same reference numerals, and duplicate explanation is omitted.

An air battery shown in FIGS. 7 and 8 comprises a first electrode group 2a and a second electrode group 2b. The first electrode group 2a and second electrode group 2b are obtained respectively by arranging the negative electrode active material layer 6 at both surfaces of the negative electrode current collector 5, covering the obtained negative electrode with the separator 7, and laminating the positive electrode layer 4 and the positive electrode current collector 3. The first electrode group 2a and second electrode group 2b are contained in a bag formed of the barrier film group 11, respectively. This bag is formed by covering the electrode group 2 with the barrier film group 11, and laminating the ends of the barrier film group 11 by heat sealing. The air positive electrode of each electrode group is opposite to the gap holding member 10a of the barrier film group 11. The air positive electrode of each electrode group is also opposite to the air pores 8 by way of the barrier film group 11. Spacer particles 15 are arranged between the barrier film group 11 covering the first electrode group 2a and the barrier film group 11 covering the second electrode group 2b. As a result, a gap can be formed between unit cells, and distribution of air in the battery container is smooth.

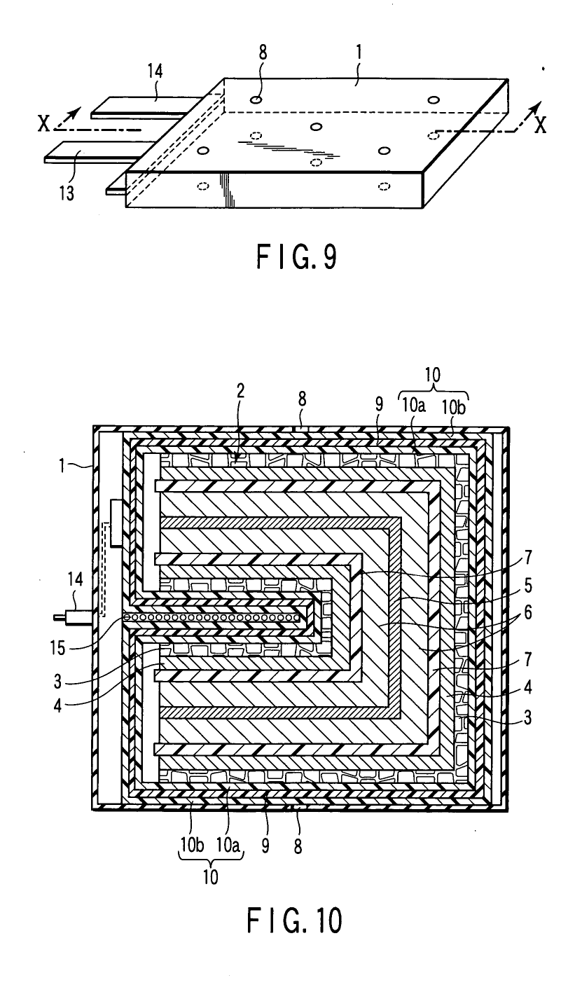

On the other hand, the electrode group 2 of the air battery shown in FIGS. 9 and 10 is obtained by arranging the negative electrode active material layer 6 at both surfaces of the negative electrode current collector 5, laminating the separator 7 on each negative electrode active material layer 6, laminating the positive electrode layer 4 and the positive electrode current collector 3 on each separator 7, and bending the obtained laminated body in a U shape. The electrode group 2 is covered with the barrier film group 11, and ends of the barrier film group 11 are laminated by heat sealing. The air positive electrode of the electrode group 2 is opposite to the gap holding member 10a of the barrier film group 11. The air positive electrode of the electrode group 2 is also opposite to the air pores 8 by way of the barrier film group 11. At the confronting position of the barrier film groups 11, spacer particles 15 are interposed between the barrier film groups 11.

In the air battery shown in FIGS. 7 to 10, as the discharge progresses, the pressure becomes negative in the bag formed of the barrier film group 11, so that the entire surface of the electrode group can be pressurized uniformly by the pressure difference from the atmospheric pressure. Therefore, the contact is held favorably among the air positive electrode, separator and negative electrode, so that a high discharge capacity is maintained during use for a long period.

Incidentally, in the case of a battery container using a coin type metal container as in an air zinc battery, the barrier film group is arranged inner surface of the positive electrode container to cover the air pores, and the positive electrode container and negative electrode container are crimped and fixed with the end of the barrier film group held between the positive electrode container and the negative electrode container, so that the barrier film group can be fixed in the positive electrode container.

The air positive electrode, negative electrode, separator, and barrier film group (laminated sheet) are specifically described below.

1) Air Positive Electrode

The air positive electrode uses oxygen as a positive electrode active material. The oxygen is not stored in the air positive electrode but rather it is accessed from the enviroment.

The air positive electrode comprises a positive electrode current collector, and a gas diffusion positive electrode layer carried on this positive electrode current collector.

As the positive electrode current collector, it is preferred to use a porous conductive substrate (mesh, punched metal, expanded metal, etc.) in order to improve diffusion of oxygen. Materials for the conductive substrate include stainless steel, nickel, aluminum, iron, titanium, and the like. The current collector may have the surface coated with antioxidant metal or alloy to suppress oxidation.

The gas diffusion positive electrode layer can be formed, for example, by mixing a carbonaceous material and a binder, pressing this mixture into a film, and drying.

The air positive electrode can be also obtained by mixing a carbonaceous material and a binder in a solvent, applying the mixture on a current collector, drying, and pressing.

On the surface of the carbonaceous material, further, fine particles having a function of lowering the overvoltage for generating oxygen such as cobalt phthalocyanine may be carried, and the efficiency of reducing reaction of oxygen can be enhanced.

By adding a highly conductive carbon material such as acetylene black to the carbonaceous material, the conductivity of the positive electrode layer can be enhanced.

As the binder for maintaining the positive electrode layer in a laminar shape and adhering to the current collector, usable examples include polytetrafluoroethylene (PTFE), polyvinylidene fluoride (PVdF), ethylene-propylene-butadiene rubber (EPBR), and styrene-butadiene rubber (SBR).

The blending rate of the carbonaceous material and binder is preferred to be in a range of 70 to 98 wt. % of the carbonaceous material, and 2 to 30 wt. % of the binder.

2) Negative Electrode

The negative electrode comprises a negative electrode current collector, and a negative electrode active material layer carried on the negative electrode current collector.

As the negative electrode current collector, not limited to a porous conductive substrate as in the positive electrode current collector, a nonporous conductive substrate can be used. Such conductive substrates are formed of, for example, copper, stainless steel, or nickel.

The negative electrode active material layer may contain a binder.

The negative electrode can be manufactured, for example, by kneading the negative electrode active material and binder in the presence of a solvent, applying the obtained suspension on the current collector, drying, and pressing once or in multiple steps of 2 to 5 times.

As the negative electrode active material, for example, a material capable of intercalating and deintercalating lithium ions can be used. The material capable of intercalating and deintercalating lithium ions includes metal oxide, metal sulfide, metal nitride, lithium metal, lithium alloy, lithium composite oxide, carbonaceous material intercalating and deintercalating lithium ions, and the like, but not limited to these examples, all materials conventionally used in the lithium ion battery or lithium battery can be used. The negative electrode active material is not limited to one type, but two or more types may be used.

The carbonaceous material capable of intercalating and deintercalating lithium ions includes, for example, graphitized or carbonaceous material such as graphite, coke, carbon fiber or spherical carbon, and graphitized or carbonaceous material obtained by heat treatment at 500 to 3000° C. from thermosetting resin, isotropic pitch, mesophase pitch, mesophase pitch based carbon fiber, mesophase pitch based microbeads, etc.

Examples of the metal oxide include tin oxide, silicon oxide, lithium titanium oxide, niobium oxide, tungsten oxide, etc.

Examples of the metal sulfide include tin sulfide, titanium sulfide, etc.

Examples of the metal nitride include lithium cobalt nitride, lithium iron nitride, lithium manganese nitride, etc.

Examples of the lithium alloy include lithium aluminum alloy, lithium tin alloy, lithium lead alloy, lithium silicon alloy, etc.

Examples of the binder include polytetrafluoroethylene (PTFE), polyvinylidene fluoride (PVdF), ethylene-propylene-butadiene rubber (EPBR), styrene-butadiene rubber (SBR), carboxy methyl cellulose (CMC), etc.

The blending rate of the carbonaceous material and binder is preferred to be in a range of 80 to 98 wt. % of the carbonaceous material, and 2 to 20 wt. % of the binder.

As the negative electrode active material, when a metal material is used such as lithium metal or lithium alloy, such a metal material can be processed into a sheet, so that the negative electrode active material layer can be formed without using the binder. Further, the negative electrode active material layer formed of such a metal material can be directly connected to the negative electrode terminal.

Incidentally, when the air battery of one embodiment of the present invention is used as a primary battery, the negative electrode active material is required to have a function of deintercalating metal ions, and is not required to have a function of intercalating metal ions.

3) Nonaqueous Electrolyte

As the nonaqueous electrolyte, both liquid type and solid type can be employed.

In the liquid type, the nonaqueous electrolyte is a liquid prepared by dissolving a lithium salt in a nonaqueous solvent. As the nonaqueous solvent, any nonaqueous solvent known as a solvent for lithium secondary battery can be used. It is preferred to use a nonaqueous solvent mainly composed of, for example, propylene carbonate (PC), ethylene carbonate (EC), their mixed solvent (called first solvent), or mixed solvent with one or more nonaqueous solvents (called second solvent) of lower viscosity than each of PC and EC and with the number of donors of 18 or less.

As the second solvent, it is preferred to use a chain carbonate containing ester carbonate bond or ester bond in the molecule, including, among others, dimethyl carbonate (DMC), ethyl methyl carbonate (EMC), diethyl carbonate (DEC), methyl propyl carbonate (MPC), isopropiomethyl carbonate, ethyl propionate, methyl propionate, γ-butyrolactone (γ-BL), ethyl acetate, and methyl acetate. These second solvents may be used alone or in mixture of two or more types. The boiling point of the second solvent is preferred to be 90° C. or more.

The content of the EC or PC in the mixed solvent is preferred to be 10 to 80% by volume. More preferably, the content of the EC or PC is 20 to 75% by volume.

Specific examples of the mixed solvent include EC and PC, EC and DEC, EC and PC and DEC, EC and γ-BL, EC and γ-BL and DEC, EC, PC and γ-BL, and EC and PC and γ-BL and DEC, and the ratio of EC by volume in these mixed solvents preferred to be 10 to 80%. More preferably, the ratio of the EC by volume is in a range of 25 to 65%.

As the electrolyte, examples of the lithium salt include lithium perchlorate (LiClO₄), lithium hexafluoro phosphate (LiPF₆), lithium tetrafluoro borate (LiBF₄), lithium trifluoro meta-sulfonate (LiCF₃SO₃), and lithium bistrifluoromethane sulfonyl imide [LiN(CF₃SO₂)₂], but may also include others.

The amount of the electrolyte dissolved in the nonaqueous solvent is preferred to be 0.5 to 2.5 mol/L.

When using a liquid nonaqueous electrolyte layer, a nonaqueous electrolyte layer can be formed by impregnating and holding the liquid nonaqueous electrolyte in the separator.

As the separator, various materials can be used, such as a porous film containing polyethylene, polypropylene, or polyvinylidene fluoride (PVdF), a synthetic resin nonwoven fabric, or a glass fiber nonwoven fabric.

The porosity of the separator is preferred to be in a range of 30 to 90%. The reason is as follows. If the porosity is less than 30%, it may be difficult to obtain a high electrolytic solution holding property in the separator. On the other hand, if the porosity is over 90%, sufficient separator strength may not be obtained. A more preferred range of the porosity is 35 to 60%.

When using a solid nonaqueous electrolyte layer, a film containing a polymer material a lithium salt dissolved therein can be used as a polymer solid electrolyte. The polymer material includes, for example, polyethylene oxide (PEO), polyvinylidene fluoride (PVdF), and polyacrylonitrile (PAN). The lithium salt includes same as above, that is, lithium perchlorate (LiClO₄), lithium hexafluoro phosphate (LiPF₆), lithium tetrafluoro borate (LiBF₄), lithium trifluoro meta-sulfonate (LiCF₃SO₃), lithium bistrifluoromethane sulfonyl imide [LiN(CF₃SO₂)₂], and the like.

In the solid electrolyte layer, moreover, it is preferred to add an organic solvent in order to enhance the ion conductivity. Examples of the organic solvent include ethylene carbonate (EC), propylene carbonate (PC), γ-butyrolactone (γ-BL), carbonate containing fluorine, chain carbonate, etc. These organic solvents may be used either alone or in combination of two or more types.

4) Barrier Film Group (Laminated Sheet)

The barrier film group comprises a barrier film with an oxygen permeation coefficient of 1×10⁻¹⁴ mol·m/m²·sec·Pa or less, and a first gap holding member provided between the barrier film and the air positive electrode.

The thinner the barrier film, the greater is the gas permeation, but since the mechanical strength is lowered, a second gap holding member functioning as the protective layer of the barrier film and gas diffusion layer may be provided between the barrier film and the battery container.

When the gap of the first gap holding member is filled with the electrolyte, the gas diffusion function of the first gap holding member is lowered, and hence the surface of the first gap holding member may be treated with oil repellent or the like.

(Barrier Film)

Since the barrier film has a function of passing oxygen selectively, the oxygen in the air may be enriched and supplied into the electrode group in the battery, so that secondary reaction between the moisture or nitrogen in the air and the negative electrode active material can be prevented. Hence, the oxygen gas permeation coefficient of the barrier film is preferred to be at least two times of the nitrogen gas permeation coefficient. More preferably, it should be 2.2 times or more.

The barrier film is preferred to be highly hydrophobic in order to arrest infiltration of moisture in the air into the electrode group. Hydrophobic thermoplastic resins include polyolefins such as polyethylene, polypropylene, polybutadiene, and polymethyl pentene; fluorine resins such as polyvinylidene fluoride, and vinyl trifluoride-vinylidene fluoride copolymer; polyphenylene sulfide; and the like. These thermoplastic resins may be partially crosslinked by electron beam irradiation in order to enhance resistance to the organic solvent in the nonaqueous electrolyte.

Besides, the layer contacting with the nonaqueous electrolyte may be made of a multilayer film formed of a thermoplastic resin high in resistance to the organic solvent.

The thickness of the barrier film is preferred to be in a range of 1 μm to 100 μm. The reason is as follows. If the thickness of the barrier film is less than 1 μm, the mechanical strength is inferior, so that the barrier film may be torn due to ambient temperature changes or during handling. If the thickness of the barrier film is more than 100 μm, since the oxygen permeation coefficient of the barrier film is small, enough output may not be obtained from the battery. A more preferred range of the barrier film thickness is 2 to 20 μm.

(Gap Holding Member)

Materials usable as the gap holding member include a porous film having penetration holes which parallels to the thickness direction; flat and permeable materials such as woven fabric, nonwoven fabric, and paper; and the like.

As raw materials for forming the gap holding member, those not dissolved, swollen or decomposed in the nonaqueous electrolyte are preferred, and such examples include polyolefins such as polyethylene, polypropylene, polymethyl pentene, and denatured copolymers that contains olefin; fluorine resins such as polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ETFE), polyvinylidene fluoride (PVdF), and polychlorotrifluoroethylene (PCTFE); engineering plastics such as polyphenylene sulfide (PPS), polyethylene terephthalate (PET), polybutylene terephthalate (PBT), and polyether ether ketone (PEEK); cellulose and denatured formal; and the like.

The thickness of the gap holding member is preferred to be in a range of 10 to 500 μm. The reason is as follows. If the thickness is less than 10 μm, the gap holding member is small in rigidity, and is likely to deform, so that it is hard to maintain a gap between the barrier film and the gas diffusion positive electrode. On the other hand, if using the gap holding member thicker than 500 μm, it is not preferred because the power density (W/L) is lowered. A more preferred range of the thickness of the gap holding member is 15 to 300 μm.

The porosity of the gap holding member is preferred to be in a range of 10 to 90%. The reason is as follows. If the porosity is less than 10%, the speed of oxygen gas diffusing through the gap holding member is slow, and the high rate characteristic of the battery may be lowered. Besides, since the gap holding characteristic is low, its function may not be exhibited sufficiently. On the other hand, if the porosity exceeds 90%, the mechanical strength is inferior, so that the gap holding member may be torn due to ambient temperature changes or during handling. A more preferred range of the porosity of the gap holding member is 20 to 80%.

The air permeability of the gap holding member is preferred to be 1000 sec/100 cm³ or less. If the air permeability exceeds 1000 sec/100 cm³, the speed of oxygen gas diffusing through the gap holding member is slow, and the high rate characteristic of the battery may be lowered. Although the smaller the permeability, the faster becomes the oxygen diffusion speed of the gap holding member, if the air permeability is less than 1 sec/100 cm³, the circulation of air between inside and outside isolated by the gap holding member is promoted, so that the inside may not be held at negative pressure, and hence the air permeability should be preferably kept in a range of 1 to 1000 sec/100 cm³. A more preferred range of the air permeability of the gap holding member is 2 to 800 sec/100 cm³.

Between the polymer barrier film and the gas diffusion positive electrode, it is also effective to provide spacer particles instead of the gap holding member or together with the gap holding member. The shape of such spacer particles is preferred to be spherical or particulate so as not to damage the polymer barrier film. The particle size of spacer particles is preferred to be 10 to 500 μm. The reason is as follows. If the particle size is less than 10 μm, particles are more likely to be filled into the gas diffusion positive electrode, so that it is hard to form gaps between the barrier film and the gas diffusion positive electrode. If the particle size is over 500 μm, the volume of gaps is too large, so that it is not preferred because the power density (W/L) is lowered.

Further, it is possible to obtain a gap holding layer by forming recesses on the contact surface of the gas diffusion positive electrode with the polymer barrier film. The size of recesses of this gas diffusion positive electrode is also preferred to be in a range of 10 to 500 μm from the reason explained below. If the recess size is less than 10 μm, it is hard to form gaps between the barrier film and the gas diffusion positive electrode due to the surface roughness of the gas diffusion positive electrode. If the recess size exceeds 500 μm, the volume of the gaps increases, so that it is not preferred because the power density (W/L) is lowered.

Incidentally, when roughening the air positive electrode surface or providing particles as the spacer, if the barrier film rigidity is sufficiently large, the function of holding gaps may be sufficiently exhibited. However, if the thickness of the barrier film is reduced, in the case where the pressure becomes negative in the battery, the barrier film is deformed after the air positive electrode surface or spacer shape, and gaps may not be held. In addition, when the air positive electrode surface is roughened, high power density (W/L) may not be obtained, or the air positive electrode density may not be uniform in the area direction.

Herein, as one embodiment of the invention, the air lithium battery comprising the nonaqueous electrolyte is explained, but when manufacturing other air metal batteries, sodium, aluminum, magnesium, or cesium may be used as the negative electrode active material, and metal salt of sodium, aluminum, magnesium, or cesium may be used as the electrolyte. Further, these air metal batteries may be used as the secondary batteries by using negative electrode active material capable of intercalating and deintercalating each of these metals.

Embodiments of the present invention will be explained with reference to the drawings.

### EXAMPLE 1

An aluminum-containing laminate film containing a polypropylene thermoplastic resin layer and an aluminum layer was prepared. Since the aluminum-containing laminate film has a Young's modulus Y of 8×10³ MPa and thickness T of 100×10⁻⁶ m, the aluminum-containing laminate film satisfies the foregoing formula (1){(Y×T)<10²}. The aluminum-containing laminate film was formed into a cup with a lid, and five air pores of 2 mm in diameter were formed in the lid as the air positive electrode opposite surface, and a battery container was prepared. At this time, the polypropylene layer was set as the inner surface of the battery container. A seal tape was adhered to the outer surface of the lid to seal the air pores.

As the barrier film, a polyethylene film having the thickness of 10 μm and an oxygen permeation coefficient as shown in Table 1 was prepared. The oxygen permeation coefficient of the barrier film was measured in a method conforming to JIS (Japanese Industrial Standards) K 7126. A polyethylene microporous film having the thickness, porosity and permeability as specified in Table 1 was prepared as gap holding member. The air permeability of the gap holding member can be measured by the air permeability testing method for paper and sheet paper specified in JIS P 8117. As shown in FIG. 3, the gap holding member was folded in two, and the barrier film is placed between them to obtain a barrier film group as a laminated sheet. The ends of the barrier film group were fused to the inner surface of the lid (polypropylene layer) of the battery container by heat fusion process as shown in FIG. 4.

90 wt. % of Ketjen Black (EC600JD™) and 10 wt. % of polytetrafluoroethylene powder were mixed by dry process, the resultant mixture was kneaded and pressed, thereby obtaining a film-like gas diffusion positive electrode layer in a size of 50 mm by 30 mm and thickness of 200 μm. This positive electrode layer was press-bonded to a titanium mesh of the positive electrode current collector, and an air positive electrode was obtained. One end of a positive electrode lead was connected to an exposed portion of the positive electrode current collector of the obtained positive electrode.

A negative electrode was prepared by press-bonding a metal lithium foil to a nickel mesh having one end of a negative electrode lead electrically connected thereto, and also a separator made of a glass filter was prepared.

The negative electrode, separator, and positive electrode were sequentially laminated, and this laminated body was put in a cup of the battery container. At this time, the laminated body was placed so that the air positive electrode was opposite to the air pores of the battery container. The ends of the air positive electrode lead and negative electrode lead were extended outside from between the cup and the lid.

In a nonaqueous solvent mixing 50 vol. % of ethylene carbonate and 50 wt. % of propylene carbonate, an electrolyte of lithium perchlorate was dissolved at a concentration of 1.0 mol/L, and a liquid nonaqueous electrolyte was prepared.

After the liquid nonaqueous electrolyte was poured into the separator and immersed in the separator, the battery container was sealed by fusing the lid to the cup, and a nonaqueous electrolyte battery was manufactured. Immediately after heat sealing, the pressure in the battery container was slightly lower than the atmospheric pressure because the battery container was enclosed by heat sealing, but the pressure difference was less than 0.1 kPa.

This battery was discharged in a glove box filled with dry air kept at dew point of 65° C. or less, continuously until 2.0 V at constant rate of 0.02 mA per 1 cm² of positive electrode, and by constant voltage discharge at 2.0 V, the discharge capacity in 60 days was measured. Further, in a thermostatic oven at temperature of 25° C. and humidity of 30%, after continuous discharge until 2.0 V at constant rate of 0.02 mA per 1 cm² of positive electrode, by constant voltage discharge at 2.0 V, the discharge capacity in 60 days was measured. Moreover, in a thermostatic oven at temperature of 25° C. and humidity of 80%, after continuous discharge until 2.0 V at constant rate of 0.02 mA per 1 cm² of positive electrode, by constant voltage discharge at 2.0 V, the discharge capacity in 60 days was measured.

The results are shown in Table 2, supposing the capacity obtained by discharge in the glove box to be 100%.

### EXAMPLE 2

The air battery in the same composition as in Example 1 was manufactured except for the following: the barrier film was a three-layer film of polyethylene (PE), polypropylene (PP), and polyethylene (PE) in a thickness of 12 μm having the oxygen permeation coefficient as shown in Table 1, the gap holding member was a polypropylene nonwoven fabric of thickness, porosity and permeability as shown in Table 1, and the battery structure was as shown in FIGS. 5 and 6.

The pressure in the battery container immediately after manufacture of the battery was slightly lower than the atmospheric pressure because the battery container was enclosed by heat sealing, but the pressure difference was less than 0.1 kPa.

The discharge characteristics of the obtained battery were measured under the same conditions as in Example 1, and the results are shown in Table 2.

### EXAMPLE 3

The air battery in the same composition as in Example 1 was manufactured except for the following: the barrier film was a polymethyl pentene film of 10 μm in thickness and having the oxygen permeation coefficient as shown in Table 1, and the battery structure was as shown in FIGS. 7 and 8.

The pressure in the bag formed of the barrier film group immediately after manufacture of the battery was slightly lower than the atmospheric pressure because the-battery container was enclosed by heat sealing, but the pressure difference was less than 0.1 kPa.

The discharge characteristics of the obtained battery were measured under the same conditions as in Example 1, and the results are shown in Table 2.

### EXAMPLE 4

The air battery in the same composition as in Example 1 was manufactured except that the battery structure was as shown in FIGS. 9 and 10.

The pressure in the bag formed of the barrier film group immediately after manufacture of the battery was slightly lower than the atmospheric pressure because the battery container was enclosed by heat sealing, but the pressure difference was less than 0.1 kPa.

The discharge characteristics of the obtained battery were measured under the same conditions as in Example 1, and the results are shown in Table 2.

### EXAMPLE 5

The air battery in the same composition as in Example 1 was manufactured except for the following: the barrier film was a polybutadiene film in a thickness of 50 μm having the oxygen permeation coefficient as shown in Table 1, the gap holding member was a polypropylene nonwoven fabric of thickness, porosity and permeability as shown in Table 1, and the battery structure was as shown in FIGS. 5 and 6.

The pressure in the battery container immediately after manufacture of the battery was slightly lower than the atmospheric pressure because the battery container was enclosed by heat sealing, but the pressure difference was less than 0.1 kPa.

The discharge characteristics of the obtained battery were measured under the same conditions as in Example 1, and the results are shown in Table 2.

### COMPARATIVE EXAMPLE 1

The air battery in the same composition as in Example 1 was manufactured except that the barrier film was a polydimethyl siloxane film in a thickness of 50 μm having the oxygen permeation coefficient as shown in Table 1.

The pressure in the battery container immediately after manufacture of the battery was slightly lower than the atmospheric pressure because the battery container was enclosed by heat sealing, but the pressure difference was less than 0.1 kPa.

The discharge characteristics of the obtained battery were measured under the same conditions as in Example 1, and the results are shown in Table 2.

### COMPARATIVE EXAMPLE 2

The air battery in the same composition as in Example 1 was manufactured except that the barrier film was a polytetrafluoroethylene porous film (tradename: Goretex) in a thickness of 50 μm having the oxygen permeation coefficient as shown in Table 1.

In the battery of Comparative example 2, since the air is free to move through the porous film, the pressure in the battery container immediately after manufacture of the battery was same as the atmospheric pressure.

The discharge characteristics of the obtained battery were measured under the same conditions as in Example 1, and the results are shown in Table 2.

TABLE 1

| | Barrier film | | | | | | |
|---|---|---|---|---|---|---|---|
| | | | Oxygen | | | | |
| | | | permeation | | | | |
| | | | coefficient | Gap holding member | | | |
| | | Thickness | (mol · m/m² · | | Thickness | Porosity | Permeability |
| | Material | (μm) | sec · Pa) | Material | (μm) | (%) | (sec/100 cm³) |
| Example 1 | Polyethylene | 10 | 7.1 × 10⁻¹⁶ | Polyethylene | 16 | 40 | 450 |
| | non-porous film | | | | | | |
| Example 2 | PE/PP/PE three-layer | 12 | 6.4 × 10⁻¹⁶ | Polypropylene | 100 | 70 | 4.5 |
| | non-porous film | | | | | | |
| Example 3 | Polymethyl pentene | 10 | 4.9 × 10⁻¹⁵ | Polyethylene | 16 | 40 | 450 |
| | non-porous film | | | | | | |
| Example 4 | Polyethylene | 10 | 7.1 × 10⁻¹⁶ | Polyethylene | 16 | 40 | 450 |
| | non-porous film | | | | | | |
| Example 5 | Polybutadiene | 50 | 1.0 × 10⁻¹⁴ | Polypropylene | 100 | 70 | 4.5 |
| | non-porous film | | | | | | |
| Comparative | Polydimethyl siloxane | 50 | 1.4 × 10⁻¹³ | Polyethylene | 16 | 40 | 450 |
| Example 1 | non-porous film | | | | | | |
| Comparative | Polytetrafluoroethylene | 50 | 2.3 × 10⁻¹⁰ | Polyethylene | 16 | 40 | 450 |
| Example 2 | porous film | | | | | | |

TABLE 2

| | | | | | | Difference | |
|---|---|---|---|---|---|---|---|
| | | | | Battery specification | | between internal | |
| | Capacity maintenance | | | | Gas | pressure and | Contact |
| | rate (%) | | | Battery | diffusion | atmospheric | tightness |
| | 60 days | 60 days | 60 days | container | positive | pressure in | of |
| | in glove | at 25° C., | at 25° C., | sectional | electrode | stationary state | electrode |
| | box | 30% | 80% | area (cm²) | area (cm²) | during discharge | group |
| Example 1 | 100 | 92 | 80 | 16 | 15 | 1 to 3 kPa | Excellent |
| Example 2 | 100 | 85 | 78 | 16 | 30 | 2 to 4 kPa | Excellent |
| Example 3 | 100 | 75 | 60 | 16 | 60 | 0.5 to 1 kPa | Excellent |
| Example 4 | 100 | 96 | 83 | 16 | 60 | 1 to 3 kPa | Excellent |
| Example 5 | 100 | 80 | 65 | 16 | 30 | 1 to 2 kPa | Excellent |
| Comparative | 100 | Battery | Battery | 16 | 15 | Internal | Poor |
| Example 1 | | swollen | swollen | | | pressure higher | |
| | | | | | | than atmospheric | |
| | | | | | | pressure by | |
| | | | | | | discharge | |
| Comparative | Failure | Battery | Battery | 16 | 15 | No difference | Poor |
| Example 2 | in | swollen | swollen | | | | |
| | 20 days | | | | | | |

In the battery of Example 1, the discharge capacity after continuous discharge for 60 days in the glove box was about 420 mAh. When converted into the capacity per positive electrode-carbon weight, this value is a large capacity of about 4000 mAh/g, being about twice the value of a comparative example. As in clear from Tables 1 and 2, the air batteries in Examples 1 to 5 are small in capacity drop when discharged at atmospheric pressure, and in particular the performance nearly equal to discharge in the glove box is obtained in the batteries of Examples 1 and 4.

Further, in the air batteries in Examples 1 to 5, in the stationary discharge state in the above three conditions, the difference between the battery internal pressure and the atmospheric pressure was sufficient, and the contact tightness of the electrode group in the discharge state was excellent.

By contrast, in the air battery of Comparative example 1 of which the oxygen permeation coefficient of the barrier film was more than 1×10⁻¹⁴ mol·m/m²·sec·Pa, the battery container was swollen by penetration of moisture during discharge at the atmospheric pressure, so that it could not withstand continuous discharge for 60 days. In addition, in the air battery of Comparative example 1, in the stationary discharge state in the above three conditions, the difference between the battery internal pressure and the atmospheric pressure was less than 0.1 kPa in initial phase of discharge and there was almost no difference, so that, as the battery voltage dropped along with penetration of moisture, the battery internal pressure became higher than the atmospheric pressure. In the discharge state, the contact tightness of the electrode group was poor.

On the other hand, the air battery of Comparative example 2 using a porous film instead of the barrier film was very inferior in stability even in comparison with Comparative example 1, and the nonaqueous electrolytic solution was dried up in the glove box and the operation failed in 20 days. In the thermostatic oven, swelling of the battery due to penetration of moisture took place earlier than in Comparative example 1, and continuous discharge for 60 days was disabled. In the stationary discharge state in the above three conditions, there was almost no difference between the battery internal pressure and the atmospheric pressure, and the contact tightness of the electrode group was defective.

A side pocket was provided in the battery container of the battery of Example 1, and a pressure sensor was buried in the pocket to prepare a test cell. During continuous discharge of the test cell in the moist atmosphere of humidity of 90% and temperature of 23° C., changes of pressure, current and internal pressure of the battery container were measured, and results are shown in FIG. 11. In FIG. 11, the abscissas denotes the discharge time, the left side ordinates represents the voltage and current, and the right side ordinates shows the internal pressure of the battery container. As clear from FIG. 11, in the initial phase of discharge, the pressure was positive to the atmospheric pressure, but the pressure in the battery container declined gradually along with progress of discharge, and finally became negative. During discharge, the current and voltage were almost constant, and it is known that the stability of current-voltage characteristic of the battery of Example 1 is high.

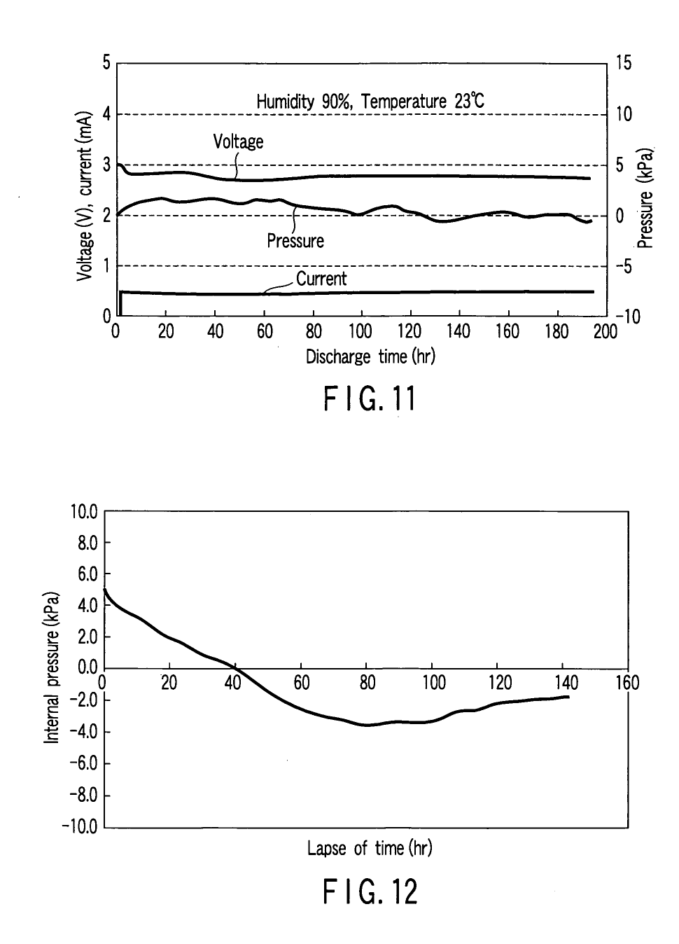

Besides, after the metallic container was filled with argon gas, and its opening was closed with a barrier film of the same type as explained in Example 1, changes in gas pressure in the metallic container were measured, and results are shown in FIG. 12. In FIG. 12, the ordinates denotes the internal pressure of the metallic container, and the abscissas represents the lapse of time. As clear from FIG. 12, the pressure in the metallic container declined gradually with the lapse of time. Although the mechanism of argon gas passing through the barrier film is unknown, there was an evident phenomenon of the argon gas in the metallic container flowing out to the atmosphere through the barrier film until the pressure becomes negative of the atmospheric pressure.

As described herein, one embodiment of the present invention provides an air battery excellent in contact tightness of the electrode group, and large in battery capacity for a long period at atmospheric pressure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An air battery comprising:
a battery container having a surface in which air pores are formed;
an electrode group provided in the battery container and including an air positive electrode, a negative electrode, and a separator provided between the air positive electrode and the negative electrode; and
a laminated sheet including a barrier film which is provided between the surface of the battery container and the air positive electrode of the electrode group, and of which oxygen permeation coefficient is 1×10⁻¹⁴ mol·m/m²·sec·Pa or less, and a gap holding member which is laminated on the barrier film and is opposite to the air positive electrode, and the gap holding member comprising at least one selected from the group consisting of a porous film, a nonwoven fabric, and a woven fabric,
wherein the air pores of the battery container are closed by the laminated sheet.

2. An air battery according to claim 1, wherein the internal pressure in the battery container during continuous discharge is lower than the atmospheric pressure by 0.1 to 80 kPa.

3. An air battery according to claim 1, wherein the ratio of the gap in the battery container except for the portion of the laminated sheet is 5 to 40%.

4. An air battery according to claim 1, wherein the battery container is formed of a laminate film containing aluminum and satisfying the following formula (1):
(Y×T)<10² (1)
where Y is Young's modulus (MPa) of the laminate film, and T is the thickness (m) of the laminate film.

5. An air battery according to claim 1, wherein the barrier film is formed of a hydrophobic material containing at least one polymer selected from the group consisting of polyolefin, fluoroplastic, and polyphenylene sulfide, and the thickness of the barrier film is in a range of 1 to 100 μm.

6. An air battery according to claim 1, wherein the thickness of the gap holding member is in a range of 10 to 500 μm.

7. An air battery according to claim 1, wherein the porosity of the gap holding member is in a range of 10 to 90%.

8. An air battery according to claim 1, wherein the air permeability of the gap holding member is 1000 sec/100 cm³ or less.

9. An air battery according to claim 1, wherein the porous film, nonwoven fabric and woven fabric are formed of a hydrophobic material containing at least one polymer selected from the group consisting of polyolefin, fluoroplastic, polyphenylene sulfide, polyethylene terephthalate, polybutylene terephthalate, and polyether ether ketone.

10. An air battery according to claim 1, wherein the laminated sheet further comprises a second gap holding member which is laminated on the barrier film and is opposite to the air pores.

11. An air battery according to claim 10, wherein the second gap holding member comprises at least one selected from the group consisting of a porous film, a nonwoven fabric, and a woven fabric.

12. An air battery according to claim 1, wherein the air positive electrode contains a carbonaceous material.

13. An air battery according to claim 1, wherein the negative electrode contains at least one negative electrode active material selected from the group consisting of a carbonaceous material capable of deintercalating an alkaline metal ion or alkaline earth metal ion, a metal compound capable of deintercalating an alkaline metal ion or alkaline earth metal ion, an alkaline metal, and an alkaline earth metal.

14. An air battery according to claim 1, further comprising an electrolyte held in the separator.

15. An air battery comprising:
a battery container having air pores;
an electrode group provided in the battery container and including an air positive electrode, a negative electrode, and a separator provided between the air positive electrode and the negative electrode; and
a laminated sheet provided between the battery container and the electrode group, and the laminated sheet comprising a barrier film of which the oxygen permeation coefficient is 1×10⁻¹⁴ mol·m/m²·sec·Pa or less, and a gap holding member which is laminated on the barrier film and comprises at least one selected from the group consisting of a porous film, a nonwoven fabric, and a woven fabric,
wherein the air positive electrode of the electrode group is opposite to the gap holding member of the laminated sheet.

16. An air battery according to claim 15, wherein the electrode group is contained in a bag formed of the laminated sheet.

17. An air battery according to claim 16, wherein the internal pressure in the bag during continuous discharge is lower than the atmospheric pressure by 0.1 to 80 kPa.

18. An air battery according to claim 16, wherein the ratio of the gap in the bag is 5 to 40%.

19. An air battery according to claim 15, wherein the battery container is formed of a laminate film containing aluminum and satisfying the following formula (1):
(Y×T)<10² (1)
where Y is Young's modulus (MPa) of the laminate film, and T is the thickness (m) of the laminate film.

20. An air battery according to claim 15, wherein the laminated sheet further comprises a second gap holding member which is laminated on the barrier film and is opposite to the air pores.
